(19) United States
(12) Patent Application Publication
(10) Pub. No.: US 2008/0201147 A1
(43) Pub. Date: Aug. 21, 2008

(54) Distributed speech recognition system and method and terminal and server for distributed speech recognition

(75) Inventors: Ick-sang Han, Yongin-si (KR); Kyu-hong Kim, Incheon (KR); Jeong-su Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/826,346

(22) Filed: Jul. 13, 2007

(30) Foreign Application Priority Data
Feb. 21, 2007 (KR) 10-2007-0017620

(51) Int. Cl. G10L 15/04

(52) U.S. Cl. 704/254

(57) ABSTRACT

Provided are a distributed speech recognition system, a distributed speech recognition speech method, and a terminal and a server for distributed speech recognition. The distributed speech recognition system includes a terminal which decodes a feature vector that is extracted from an input speech signal into a sequence of phonemes and generates the final recognition result by rescoring a candidate list provided from the outside; and a server which generates the candidate list by performing symbol matching on the recognized sequence of phonemes provided from the terminal and transmits the candidate list for the rescoring to the terminal.

### CROSS-REFERENCE TO RELATED PATENT APPLICATIONS

This application claims the priority of Korean Patent Application No. 10-2007-0017620, filed on Feb. 21, 2007, in the Korean Intellectual Property Office, the disclosure of which is incorporated herein in its entirety by reference.

### BACKGROUND OF THE INVENTION

1. Field of the Invention

The present invention relates to distributed speech recognition, and more particularly, to a distributed speech recognition system and a distributed speech recognition method which can improve speech recognition performance while reducing the amount of data sent and received between a terminal and a server, and a terminal and a server for the distributed speech recognition.

2. Description of the Related Art

Terminals, such as mobile phones or personal digital assistants (PDAs), cannot perform large vocabulary speech recognition due to the limited performance of a processor or capacity of memory of the terminals. Distributed speech recognition between such terminals and a server has been employed to ensure the performance and accuracy of speech recognition.

Conventionally, in order to perform distributed speech recognition, a terminal records input speech signals, and then transmits the recorded speech signals to a server. The server performs large vocabulary speech recognition on the transmitted speech signals, and sends the recognition result to the terminal. In this case since the terminal sends the speech waveform intact to the server, the amount of transmission data increases to about 32 Kbytes per second, and thus the channel efficiency is low, and there is an increased burden on the server.

Alternatively, according to another embodiment of conventional distributed speech recognition, a terminal extracts feature vectors from input speech signals, and transmits the extracted feature vectors to a server. The server performs large vocabulary speech recognition with the transmitted feature vectors, and sends the recognition result to the terminal. In this case the amount of transmission data decreases to 16 Kbytes per second because the terminal sends only the feature vectors to the server, but the channel efficiency is still low, and there is still a burden on the server.

### SUMMARY OF THE INVENTION

The present invention provides a distributed speech recognition system and a method which can improve speech recognition performance while substantially reducing the amount of data transmitted and received between a terminal and a server.

The present invention also provides a terminal and a server for distributed speech recognition.

According to an aspect of the present invention, there is provided a distributed speech recognition system comprising: a terminal which decodes a feature vector that is extracted from an input speech signal into a recognized sequence of phonemes; and a server which performs symbol matching on the recognized sequence of phonemes provided from the terminal and transmits a final recognition result to the terminal.

According to another aspect of the present invention, there is provided a distributed speech recognition system comprising: a terminal which decodes a feature vector that is extracted from an input speech signal into a sequence of phonemes and generates a final recognition result by rescoring a candidate list provided from the outside; and a server which generates the candidate list by performing symbol matching on the recognized sequence of phonemes provided from the terminal and transmits the candidate list for the rescoring to the terminal.

According to still another aspect of the present invention, there is provided a distributed speech recognition method comprising: decoding a feature vector which is extracted from an input speech signal into a recognized sequence of phonemes by using a terminal; receiving the recognized sequence of phonemes and generating the final recognition result by performing symbol matching on the recognized sequence of phonemes by using a server; and receiving a final recognition result, which has been generated in the server, by using the terminal.

According to yet another aspect of the present invention, there is provided a distributed speech recognition method comprising: decoding a feature vector that is extracted from an input speech signal into a recognized sequence of phonemes by using a terminal; receiving the recognized sequence of phonemes from the server and generating a candidate list by performing symbol matching on the recognized sequence of phonemes by using a server; and generating a final recognition result by rescoring the candidate list, which has been generated in the server, by using the terminal.

According to another aspect of the present invention, there is provided a terminal comprising: a feature extracting unit which extracts a feature vector from an input speech signal; a phonemic decoding unit which decodes the extracted feature vector into a sequence of phonemes and provides a server with the sequence of phonemes; and a receiving unit which receives the final recognition result from the server.

According to another aspect of the present invention, there is provided a terminal comprising: a feature extracting unit which extracts a feature vector from an input speech signal; a phonemic decoding unit which decodes the extracted feature vector into a sequence of phonemes and provides a server with the sequence of phonemes; and a detail matching unit which performs rescoring on a candidate list provided from the server.

According to another aspect of the present invention, there is provided a server comprising: a symbol matching unit which receives a recognized sequence of phonemes from a terminal and matches the recognized sequence of phonemes with a sequence of phonemes that is registered in a word list; and a calculation unit which generates a final recognition result based on a matching score of a matching result from the symbol matching unit and provides the terminal with the final recognition result.

According to another aspect of the present invention, there is provided a server comprising: a symbol matching unit which receives a recognized sequence of phonemes from a terminal and matches the recognized sequence of phonemes with a sequence of phonemes that is registered in a word list; and a calculation unit which generates a candidate list according to a matching score of a matching result from the symbol matching unit and provides the terminal with the candidate list for rescoring.

According to another aspect of the present invention, there is provided a computer readable recording medium having embodied thereon a computer program for executing a distributed speech recognition method.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for explaining a distributed speech recognition system according to an embodiment of the present invention;

FIG. 2 is a block diagram of a distributed speech recognition system according to an embodiment of the present invention;

FIG. 3 is a block diagram of a distributed speech recognition system according to another embodiment of the present invention;

FIG. 4 shows an example of matching a reference pattern with a recognition symbol sequence in a distributed speech recognition system according to an embodiment of the present invention; and

FIG. 5 is a graph comparing the amounts of transmitted and received data between the conventional distributed speech recognition method and the distributed speech recognition method according to embodiments of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

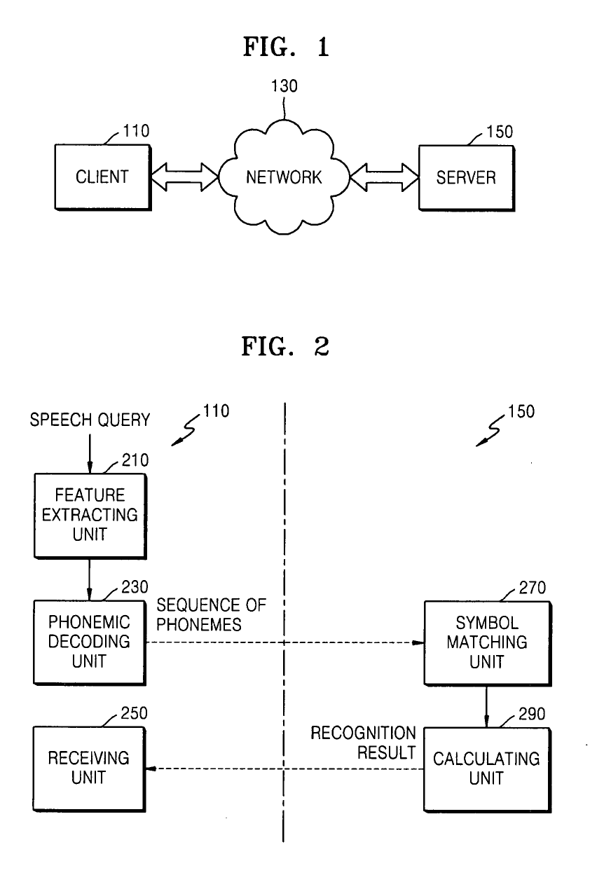

FIG. 1 is a diagram for explaining a distributed speech recognition system according to an embodiment of the present invention. The distributed speech recognition system includes a client 110, a network 130, and a server 150. The client 110 is a terminal, such as a mobile phone or a personal digital assistant, and the network 130 may be a wired or wireless network. The server 150 may be a home server, a car server, or a web server.

Referring to FIG. 1, the client 110 decodes feature vectors into a sequence of phonemes, and transmits the sequence of phonemes to the server 150 over the network 130. In the course of decoding, a speaker adaptive acoustic model or an environmentally adaptive acoustic model may be used. The server 150 performs large vocabulary speech recognition on the transmitted sequence of phonemes, and as a result of the recognition, the server 150 transmits a single word to the terminal (the client) 110 over the network 130. According to another embodiment of the present invention, the server 150 performs large vocabulary speech recognition on the sequence of phonemes, and transmits a candidate list consisting of a plurality of recognized words to the terminal 110 over the network 130. The terminal 110 performs detailed matching on the candidate list, and produces a final recognition result.

FIG. 2 is a block diagram of a distributed speech recognition system according to an embodiment of the present invention. The client 110 includes a feature extracting unit 210, a phonemic decoding unit 230, and a receiving unit 250, and the server 150 includes a symbol matching unit 270 and a calculating unit 290.

Referring to FIG. 2, when the feature extracting unit 210 receives a speech query, that is, a speech signal input from a user, the feature extracting unit 210 extracts a feature vector from the speech signal. Specifically, the feature extracting unit 210 restricts the background noise, extracts at least one speech section from the user's speech signal, and extracts a feature vector for speech recognition from the speech section.

The phonemic decoding unit 230 decodes the feature vector provided by the feature extracting unit 210 into a sequence of phonemes. The phonemic decoding unit 230 calculates a log-likelihood of all states which are activated in each frame, and performs phonemic decoding using the calculated log-likelihood. The sequence of phonemes output from the phonemic decoding unit 230 may be more than one, and it is possible to set the weight for a phoneme included in the sequence of phonemes. That is, the phonemic decoding unit 230 decodes the extracted feature vector into a single or a plurality of sequence(s) of phonemes using phoneme or tri-phone acoustic modelling. In the course of decoding, the phonemic decoding unit 230 adds constraints to the sequence of phonemes by applying phone-level grammar. Furthermore, the phonemic decoding unit 230 can apply connectivity between contexts to the tri-phone acoustic modelling. The acoustic model used by the phonemic decoding unit 230 may be a speaker or an environmentally adaptive acoustic model.

The receiving unit 250 receives the recognition result from the server 150, and allows the client 110 to perform a predetermined operation for the speech query, for example, mobile web search or music search from a large capacity database of the server 150.

The symbol matching unit 270 matches the recognized sequence of phonemes to a sequence of phonemes in a recognizable word list which is registered in a database (not shown). The symbol matching unit 270 matches the recognized sequence of phonemes, that is, the recognition symbol sequence with the registered sequence of phonemes, that is, a reference pattern, based on dynamic programming. In other words, the symbol matching unit 270 performs matching by optimum path searching for the recognition symbol sequence and the reference pattern by using phone confusion matrix and linguistic constraints as shown in FIG. 4. Moreover, the symbol matching unit 270 may start or finish matching at any point of the sequence, and also may specify the starting or ending point of matching based on linguistic knowledge, such as of words or word-phrase boundaries. Symbol sets used in the phone confusion matrix are a recognition symbol set and a reference symbol set. The recognition symbol set is used in the phonemic decoding unit 230. The reference symbol set is a phonemic set used for expressing phonemes, that is, the reference pattern, in a recognizable word list which is used in the symbol matching unit 270. The recognition symbol set and the reference symbol set may be identical, or may be different from each other. The elements of the phone confusion matrix represent the probabilities of confusion between the recognition symbols and the reference symbols, and an insertion probability of the recognition symbol and a deletion probability of the reference symbol are used to calculate the probability of confusion.

The calculating unit 290 calculates a matching score based on the matching result of the symbol matching unit 270, and provides the receiving unit 250 of the client 110 with the recognition result which is based on the matching score, that is, lexicon information of the recognized word. Here, the calculating unit 290 may output a single word that has the highest matching score or a plurality of words in order of the highest to the lowest score. The calculating unit 290 calculates the matching scores using the phone confusion matrix. In addition, the calculating unit 290 may calculate the matching score by considering the insertion and deletion probabilities of the phoneme.

In short, the client 110 provides the server 150 with the recognized sequence of phonemes which is recognized independently from the recognizable word list, and the server 150 performs the symbol matching on the recognized sequence of phonemes, the symbol matching being subject to the recognizable word list.

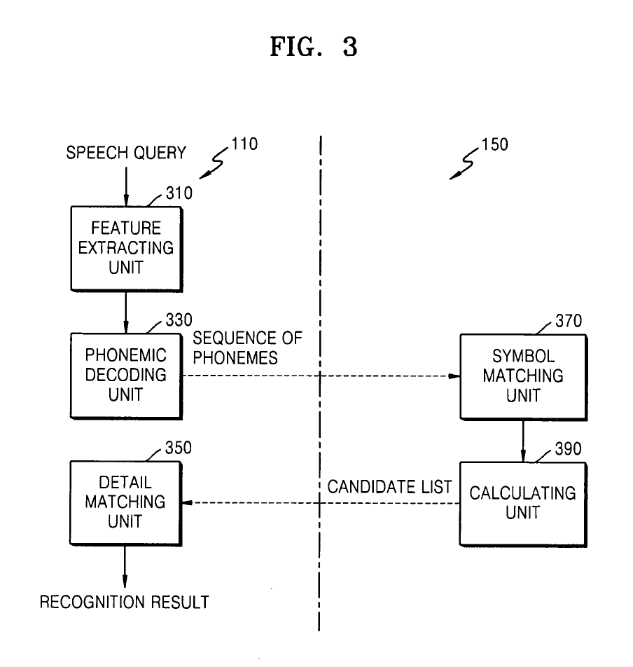

FIG. 3 is a block diagram of a distributed speech recognition system according to another embodiment of the present invention. The system includes a client 110 which includes a feature extracting unit 310, a phonemic decoding unit 330, and a detail matching unit 350, and a server 150 which includes a symbol matching unit 370, and a calculating unit 390. The operations of the feature extracting unit 310, the phonemic decoding unit 330, the symbol matching unit 370 and the calculating unit 390 are the same as the operations of those in the embodiment illustrated in FIG. 2, and thus the detailed description thereof will be omitted. However, the detail matching unit 350, which is the most different from the embodiment illustrated in FIG. 2, will be described in detail.

Referring to FIG. 3, the detail matching unit 350 rescores matched phoneme segments which are included in a candidate list provided from the server 150. The detail matching unit 350 uses the Viterbi algorithm, and may use a speaker adaptively acoustic model or an environmentally adaptive acoustic model like the phonemic decoding unit 330. The detail matching unit 350 uses as observation probability for a recognition unit, which is used to generate a sequence of phonemes in the phonemic decoding unit 330 in advance. In the detail matching unit 350, there are little calculations since the recognition unit candidates have been reduced to several or tens of candidates.

The client 110 provides the server 150 with the sequence of phonemes that is recognized independently from the recognizable word list, and the server 150 performs symbol matching, which is subject to the recognizable word list, and provides the client 110 with the recognition result of the symbol matching, that is, the candidate list including lexicon information of the recognized word. Then, the client 110 rescores the candidate list, and outputs the final recognition result.

FIG. 4 shows an example of matching the reference pattern with the recognition symbol sequence in the distributed speech recognition system according to an embodiment of the present invention.

Referring to FIG. 4, the horizontal axis shows “syaraOe” as an example of a recognition symbol sequence that is an output of the phonemic decoding unit 230 or 330, and the vertical axis shows “nvl saraOhe” as an example of a reference pattern of a recognizable word list. The distributed speech recognition system of the present invention starts matching from “syaraOe” since there is no part that matches to “nvL” of the reference pattern in the recognition symbol sequence.

Compared with the conventional distributed speech recognition method performance, the performance of the distributed speech recognition method according to the present invention will now be described.

In general, a terminal extracts the 39-dimensional feature vector while sliding an analysis window every 10 msec, and sends the extracted feature vector to a server. Assuming that a sampling rate is 16 KHz and the pitch of the sound is detected over a time period of one second by a sound detector when a user speaks “saranghe”, transmission data will be calculated as described below according to the conventional method and a method of the present invention.

First, when the terminal sends sound waveforms to the server (conventional method 1), the amount of data transmitted from the terminal to the server, that is, the number of bytes for expressing one-second sound is 32,000 bytes (=16,000×2). Meanwhile, the amount of data transmitted from the server to the terminal is 6 bytes, which corresponds to “saranghe”. Thus, the amount of data transmitted and received for the distributed speech recognition is a total of 32,006 Bytes.

Second, when the terminal sends feature vectors to the server (conventional method 2), the amount of data transmitted from the terminal to the server, that is, the number of bytes for expressing one-second of sound is 15,600 bytes (=100×156) which is obtained by multiplying the number of frames by the number of bytes consumed in each frame. Here, the number of frames is obtained by dividing 1000 msec by 10 msec, and the number of bytes consumed in each frame is obtained by multiplying 39 by 4. The amount of data transmitted from the server to the terminal is 6 bytes, which corresponds to “saranghe”. Thus, the amount of data transmitted and received for the distributed speech recognition is a total of 15,606 bytes.

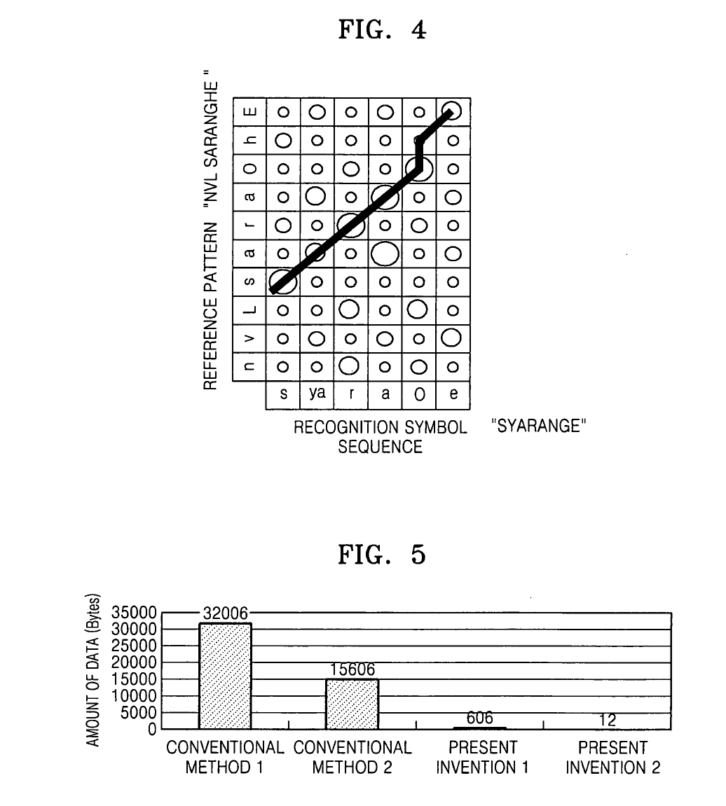

According to the embodiment of the present invention illustrated in FIG. 2 (present invention 2 in FIG. 5), a sequence of phonemes which is extracted when “saranghe” is input to the phonemic decoding unit 230 that uses 45 phoneme sets is “s ya r a O e”. In this case, 6 bits are needed to express each phoneme, and when the sequence of phonemes is expressed by 8 bits considering the multi-language extensibility, 6 bytes are used to represent six phonemes. Meanwhile, the amount of data transmitted from the server to the terminal is, on average, 6 bytes, which corresponds to a single word. Thus, the amount of data transmitted and received for the distributed speech recognition is a total of 12 bytes.

According to the embodiment of the present invention illustrated in FIG. 3 (present invention 1 in FIG. 5), when the candidate list provided to the detail matching unit 350 comprises 100 words of normally 6 bytes each, the amount of data transmitted from the server to the terminal is about 600 bytes. Thus, the amount of data transmitted and received for the distributed speech recognition is a total of 606 bytes.

FIG. 5 is a graph comparing the amounts of transmitted and received data between the conventional distributed speech recognition method and the distributed speech recognition method according to embodiments of the present invention. Referring to FIG. 5, according to the present invention, while the speech recognition performance does not deteriorate, the amounts of transmitted and received data are reduced to one-1500^{th} in the embodiment illustrated in FIG. 2, and to one-30^{th} in the embodiment illustrated in FIG. 3, respectively, and thus the communication channel efficiency can increase. Moreover, when the terminal uses a speaker adaptive acoustic model or an environmental adaptive acoustic model, the speech recognition performance can be increased substantially. That is, from the point of view of a terminal user, time spent on the distributed speech recognition is reduced substantially due to a decrease in the amount of data transmitted and received between the terminal and the server, and thus the cost of the distributed speech recognition service can be made more economical. In the meantime, from the point of view of the server, according to the present invention the server does little calculations since symbol matching is performed on a sequence of phonemes, and thus a burden on the server can be reduced, while the server of the conventional art has to do lots of calculations for observation probabilities of feature vectors. Therefore, according to the present invention, the single server can provide more services.

The distributed speech recognition method according to the present invention can also be embodied as computer readable code on a computer readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion. Functional programs, code, and code segments for implementing the present invention can be easily construed by programmers skilled in the art.

As described above, according to the present invention, a distributed speech recognition system including a terminal and a server can reduce the amount of data transmitted and received between the terminal and the server without deteriorating the speech recognition performance, thereby increasing the efficiency of a communication channel.

In addition, when the server transmits a candidate list obtained by performing symbol matching on a sequence of phonemes to the terminal, the terminal performs detail matching on the candidate list using observation probabilities which are calculated in advance, and thus the burden of the server can be reduced substantially. Accordingly, the capacity of a service that the server can provide at any given time can be increased.

Furthermore, the terminal uses a speaker adaptive acoustic model or an environmentally adaptive acoustic model for phonemic decoding and detail matching, thereby improving the speech recognition performance considerably.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A distributed speech recognition system comprising:
a terminal which decodes a feature vector that is extracted from an input speech signal into a recognized sequence of phonemes; and
a server which performs symbol matching on the recognized sequence of phonemes provided from the terminal and transmits a final recognition result to the terminal.

2. The distributed speech recognition system of claim 1, wherein the terminal performs phonemic decoding using a speaker adaptive acoustic model or an environmentally adaptive acoustic model.

3. The distributed speech recognition system of claim 1, wherein the terminal includes a feature extracting unit that extracts the feature vector from the speech signal, a phonemic decoding unit that decodes the extracted feature vector into the sequence of phonemes and provides the server with the sequence of phonemes, and a receiving unit that receives the final recognition result from the server.

4. The distributed speech recognition system of claim 1, wherein the server includes a symbol matching unit that matches the recognized sequence of phonemes provided from the terminal with a sequence of phonemes that is registered in a word list, and a calculation unit that calculates a matching score of a matching result from the symbol matching unit and provides the terminal with the final recognition result which is obtained based on the matching score.

5. A distributed speech recognition system comprising:
a terminal which decodes a feature vector that is extracted from an input speech signal into a sequence of phonemes and generates a final recognition result by rescoring a candidate list provided from the outside; and
a server which generates the candidate list by performing symbol matching on the recognized sequence of phonemes provided from the terminal and transmits the candidate list for the rescoring to the terminal.

6. The distributed speech recognition system of claim 5, wherein the terminal performs phonemic decoding using a speaker adaptive acoustic model or an environmentally adaptive acoustic model.

7. The distributed speech recognition system of claim 5, wherein the terminal includes a feature extracting unit that extracts the feature vector from the speech signal, a phonemic decoding unit that decodes the extracted feature vector into the sequence of phonemes and provides the server with the sequence of phonemes, and a detail matching unit that performs rescoring on the candidate list provided from the server.

8. The distributed speech recognition system of claim 5, wherein the server comprises a symbol matching unit that matches the recognized sequence of phonemes provided from the terminal with a sequence of phonemes that is registered in a word list, and a calculation unit that calculates a matching score of the matching result from the symbol matching unit and provides the terminal with the candidate list according to the matching score.

9. A terminal comprising:
a feature extracting unit which extracts a feature vector from an input speech signal;
a phonemic decoding unit which decodes the extracted feature vector into a sequence of phonemes and provides a server with the sequence of phonemes; and
a receiving unit which receives the final recognition result from the server.

10. The terminal of claim 9, wherein the phonemic decoding unit uses a speaker adaptive acoustic model or an environmentally adaptive acoustic model.

11. A terminal comprising:
a feature extracting unit which extracts a feature vector from an input speech signal;
a phonemic decoding unit which decodes the extracted feature vector into a sequence of phonemes and provides a server with the sequence of phonemes; and
a detail matching unit which performs rescoring on a candidate list provided from the server.

12. The terminal of claim 11, wherein the phonemic decoding unit uses a speaker adaptive acoustic model or an environmentally adaptive acoustic model.

13. A server comprising:
a symbol matching unit which receives a recognized sequence of phonemes from a terminal and matches the recognized sequence of phonemes with a sequence of phonemes that is registered in a word list; and
a calculation unit which generates a final recognition result based on a matching score of a matching result from the symbol matching unit and provides the terminal with the final recognition result.

14. A server comprising:
a symbol matching unit which receives a recognized sequence of phonemes from a terminal and matches the recognized sequence of phonemes with a sequence of phonemes that is registered in a word list; and
a calculation unit which generates a candidate list according to a matching score of a matching result from the symbol matching unit and provides the terminal with the candidate list for rescoring.

15. A distributed speech recognition method comprising:
decoding a feature vector which is extracted from an input speech signal into a recognized sequence of phonemes by using a terminal;
receiving the recognized sequence of phonemes and generating the final recognition result by performing symbol matching on the recognized sequence of phonemes by using a server; and
receiving a final recognition result, which has been generated in the server, by using the terminal.

16. The distributed speech recognition method of claim 15, wherein the terminal uses a speaker adaptive acoustic model or an environmentally adaptive acoustic model.

17. The distributed speech recognition method of claim 15, wherein the phonemic decoding of the feature vector includes extracting the feature vector from the speech signal, and decoding the extracted feature vector into the sequence of phonemes and providing the sequence of phonemes to the server.

18. The distributed speech recognition method of claim 15, wherein the generating of the final recognition result includes matching the recognized sequence of phonemes provided from the server with a sequence of phonemes that is registered in a word list and calculating a matching score of a matching result and providing the terminal with the final recognition result according to the matching score.

19. A distributed speech recognition method comprising:
decoding a feature vector that is extracted from an input speech signal into a recognized sequence of phonemes by using a terminal;
receiving the recognized sequence of phonemes from the server and generating a candidate list by performing symbol matching on the recognized sequence of phonemes by using a server; and
generating a final recognition result by rescoring the candidate list, which has been generated in the server, by using the terminal.

20. The distributed speech recognition method of claim 19, wherein the terminal uses a speaker adaptive acoustic model or an environmentally adaptive acoustic model.

21. The distributed speech recognition method of claim 19, wherein the phonemic decoding of the feature vector includes extracting the feature vector from the speech signal, and decoding the extracted feature vector into the sequence of phonemes and providing the sequence of phonemes to the server.

22. The distributed speech recognition method of claim 19, wherein the generating of the candidate list includes matching the recognized sequence of phonemes provided from the server with a sequence of phonemes that is registered in a word list and calculating a matching score of a matching result and providing the terminal with the candidate list according to the matching score.

23. A computer readable recording medium having embodied thereon a computer program for executing a distributed speech recognition method of claim 15.

24. A computer readable recording medium having embodied thereon a computer program for executing a distributed speech recognition method of claim 19.
